(19) United States
(12) Patent Application Publication
(10) Pub. No.: US 2009/0303972 A1
(43) Pub. Date: Dec. 10, 2009

(54) Dynamic Scrambling Techniques for Reducing Killer Packets in a Wireless Network

(75) Inventors: George Flammer, III, Cupertino, CA (US); Raj Vaswani, Portola Valley, CA (US)

Correspondence Address: BUCHANAN, INGERSOLL & ROONEY PC, POST OFFICE BOX 1404, ALEXANDRIA, VA, 22313-1404, US

(73) Assignee: Silver Spring Networks, Redwood City, CA (US)

(21) Appl. No.: 12/135,060

(22) Filed: Jun. 6, 2008

(51) Int. Cl. H04Q 7/24

(52) U.S. Cl. 370/338

(57) ABSTRACT

Techniques are disclosed in which a parameter used for scrambling packet data is changed. If the initial scrambling of a packet causes a killer packet to be generated, the packet is re-scrambled using a different value for the parameter, so that a killer packet is avoided. In a network that employs frequency-hopping spread spectrum communications, a channel identifier can be employed as an input to the scrambling algorithm. In this implementation, a given packet of data will be transmitted on one channel with a first sequence of bits when it is scrambled, and on another channel with a different sequence of bits. If the scrambled packet for one of these channels results in a killer packet, it is statistically unlikely that it will also be a killer packet when it is re-transmitted on the other channel.

### FIELD OF THE INVENTION

The present invention relates to secure transmission and robust reception of packets in a wireless communications network. The invention described herein addresses the problem associated with “killer packets” that plague satisfactory reception of data in a data network.

### BACKGROUND OF THE INVENTION

Due to the nature of modulators and demodulators in radio frequency (RF) data communication systems—especially simple, inexpensive systems—it is possible for a transmitting node to send a bit sequence that cannot be reliably decoded at the receiving node. One situation in which this can occur is when the transmitted bit sequence has too many zero or one bits in a row.

To accommodate changing channel conditions, the signal demodulator at the receiver dynamically self-calibrates the threshold value that is used to distinguish between logical one and logical zero bits. This can be accomplished by determining the average value of the received signal over the most recently received bits. For example, if amplitude modulation is utilized, the average amplitude of the signal is used to distinguish between a logical one bit, e.g., high amplitude, and a logical zero bit, e.g., low amplitude. Likewise, if frequency modulation is used, such as frequency shift keying, the average frequency of the received signal is employed as the threshold to detect the two different bit values encoded in a received signal.

If a sequence of bits all having the same value is received, the modulated parameter of the signal, e.g., amplitude or frequency, does not change over that sequence. Consequently, the average value of the signal, and hence the threshold value, drifts to the value of those bits. When this occurs, the demodulator is unable to reliably detect whether the received bits are ones or zeroes. If a receiver cannot successfully decode a packet, it sends an error message to the transmitter, requesting that the packet be resent. However, due to the demodulator failure with this particular type of packet, the resent version of the packet will also produce the same unsuccessful result at the receiver. This situation can trigger repeated packet transmissions. The error messages from the receiver and responsive packets from the transmitter create a bottleneck on the network that cannot be resolved. A packet containing such a sequence of bits is known as a “killer packet”—a packet that cannot be reliably processed regardless of the signal strength or the signal-to-noise ratio.

One method that has been used to prevent such an occurrence is to change the transmitted state on every bit; e.g., a low to high transition in the middle of a bit period might represent a “one” and a high to low might represent a “zero”. This is a robust technique that continuously enables the demodulator to self-calibrate. A disadvantage of this technique is that it effectively doubles the data rate (doubling the occupied on-air spectrum) while keeping the symbol rate the same. This result is particularly undesirable in bandwidth-limited wireless data networks.

Another method used to avoid the transmission of a killer packet is to scramble the data, also known as “whitening” the data. This technique involves mixing the order, or otherwise changing, the transmitted data bits such that normal bit patterns (e.g., those that might be found in text messages, or data packets with many bits of the same binary value) will not cause the transmission of long sequences of the same bit.

The scrambling technique is applied “naively”, i.e. without prior knowledge of the data. An unintended consequence of this approach is that there are some bit sequences for which the scrambling process turns previously harmless packets into killer packets. While statistically unlikely, this situation occurs in a network that transmits a large number of packets. Each time it does occur, a network bottleneck is created due to an un-resolvable packet. To mitigate this problem, additional hardware, such as a DC restoration circuit, has been incorporated into receivers to maintain the proper alignment of the threshold value, resulting in an increased cost.

### SUMMARY OF THE INVENTION

Techniques are disclosed in which a parameter used for scrambling packet data is changed. Statistically, two scramblings of the same packet of data, using different respective values for the parameter, are unlikely to both result in the creation of a killer packet. Thus, if the original data stream would result in a killer packet at the receiver mode, the initial scrambling process is likely to cure the killer packet event. However, if the initial scrambling of a packet causes a killer packet to be generated, the packet is re-scrambled using a different value for the parameter, so that a killer packet is avoided in a resent packet.

To enable a receiver to properly unscramble the packet, the parameter that is varied can be one whose value is known a priori between the transmitter and the receiver. For instance, in a network that employs frequency-hopping spread spectrum communications, the frequency of the communication channel varies on a known basis. The particular frequency channel that is being employed at any given instant is known to both the transmitter and the receiver. A channel identifier can be employed as an input to the scrambling algorithm. In this implementation, a given packet of data is transmitted on one channel with a first sequence of bits when it is scrambled, and on another channel with a different sequence of bits. Even if the scrambled packet for one of these channels results in a killer packet, it is statistically unlikely that it will also be a killer packet when it is re-transmitted on the other channel.

Other data items can be employed as the scrambling parameter. For example, if the transmitter and receiver are time-synchronized, a clock value can be used as the varied scrambling parameter. As another example, a sequence number associated with transmitted packets might be employed. As long as the varied parameter value is known by both the transmitter and receiver with known ambiguity, the scrambled data packet can be successfully unscrambled at the receiver.

In the foregoing examples, the parameter value that is employed at any given time is known a priori by both the transmitter and the receiver. In another implementation, a packet to be transmitted can have multiple scramblings applied to it with different respective parameter values, and be descrambled at the receiver with each of the different parameter values. For instance, if two different parameter values are employed to scramble the data, it is statistically unlikely that both will result in a killer packet. Consequently, at least one of the two descrambled and decoded packets at the receiver will be usable.

### BRIEF DESCRIPTION OF THE DRAWINGS

The foregoing aspects and attendant advantages of the invention will become more readily appreciated and better understood by reference to the following detailed description, when taken in conjunction with the accompanying drawings, wherein:

FIG. 1 is a block diagram of an exemplary wireless communication network in which the invention can be implemented;

FIG. 2 is an illustrative hypothetical FHSS hopping sequence;

FIG. 3 is an exemplary channel array for implementing an FHSS hopping sequence;

FIGS. 4a and 4b are block diagrams of circuits for implementing a scrambling technique at a transmitting node and a receiving node, respectively, using channel identification as the scrambling parameter;

FIG. 5 is a schematic diagram of an exemplary scrambler;

FIG. 6 is a process flow diagram of the channel index scrambling technique;

FIG. 7 is a diagram of the structure of a data packet;

FIG. 8 is a flow chart of the operation of the transmitting node in an alternate implementation; and

FIG. 9 is a logical schematic diagram of an exemplary receiver with a descrambler for the alternate implementation.

### DETAILED DESCRIPTION

The invention described herein provides mechanisms that avoid the continual re-transmission of a killer packet that may be encountered in a wireless or wireline data network. This result is accomplished by changing the actual sequence of bits in the packet itself, through variations in the scrambling of data in the packet.

To facilitate an understanding of the concepts upon which the invention is based, they are described hereinafter with reference to exemplary embodiments implemented in wireless networks that utilize FSK-modulation and Frequency-Hopping Spread Spectrum (FHSS) transmission techniques. However, it will be appreciated that these concepts can also be implemented in other types of data networks that utilize different modulation and/or transmission techniques.

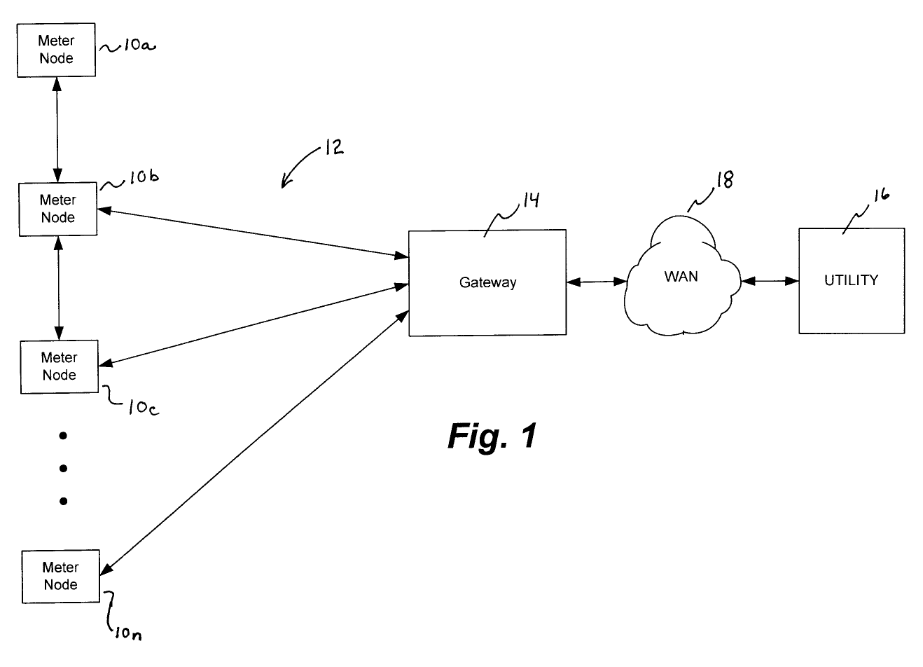

An exemplary wireless communication network, in which the concepts of the present invention can be implemented, is depicted in FIG. 1. This particular example is associated with Automated Meter Reading and Automated Meter Infrastructure (AMR/AMI) environments, in which communications take place between a commodity provider, such as a utility, and meters that monitor the usage of a commodity provided by the utility. In this type of environment, each meter that measures usage of a commodity, such as electricity, gas or water, is associated with a node 1 0 in a wireless network, such as the local area network 12. These individual nodes communicate with an access point, or gateway 14. The gateway, in turn, communicates with the utility 16, by means of a wide area network 18, e.g. a private communications network or a public communications network, such as the Internet. Some of the nodes may be able to communicate directly with the gateway over a wireless link, as depicted for the case of nodes 10b, 10c and 10n. In some cases, a node may not be able to communicate directly with the gateway via wireless link, e.g. due to geographic distances or terrain. In this case, such a node communicates with one of its neighboring nodes, which in turn communicates with the gateway, either directly or via one or more other neighboring nodes. For instance, in the illustrated example, meter node 10a communicates with the gateway 14 by means of neighboring node 10b. In effect, node 10b functions as a relay, as well as a meter node.

Although not illustrated in FIG. 1, the local area network 12 can include nodes other than meter nodes. For example, relay nodes that are not affiliated with meters might be employed to forward transmissions from the meter nodes to the gateway 14, and vice versa. As a result, the meter nodes can operate with lower transmission power than might otherwise be necessary.

As another variant, while the exemplary network of FIG. 1 employs a single gateway 14, any one or more of the meter nodes 10 might communicate with the utility 16 by any one of a plurality of gateways. Such an arrangement provides multiple redundant paths for communications between the meter nodes and the utility, thereby enhancing the robustness of the network. As another alternative, different ones of the gateways may link the nodes to different respective utilities or commodity providers.

In one implementation of the network, the wireless communications over the LAN 12 employ FHSS (Frequency-Hopping Spread Spectrum) transmissions. FHSS is a technique in which the data signal is modulated with a narrowband carrier signal that “hops” in a random but predictable sequence from frequency to frequency, as a function of time, over a wide band of frequencies. By suitable synchronization, a single logical channel is maintained.

The transmission frequencies are determined by a spreading, or hopping, code. The receiver is set to the same hopping code and listens to the incoming signal at the proper time and correct frequency in order to reliably receive the signal. Current regulations require use of 50 or more frequencies per transmission channel with a maximum dwell time (the time spent at a particular frequency during any single hop) of 400 ms.

The FHSS transmissions change channels (or hop) at a relatively fast rate. Each channel in a node's hopping sequence is visited for an amount of time called the slot time. If no reception is heard during the slot time, the node changes its receive channel to the next channel in its hopping sequence. If a reception is heard, channel hopping stops so that the reception can be processed. When a packet is to be transmitted, channel hopping stops and the packet is sent on the specified channel for its duration. Channel hopping resumes (at the frequency where it would have been if no transmission and reception of a packet had taken place) once the transaction ends.

The traversal of all the channels in a node's hopping sequence is called an epoch. The applicable regulations specify that a node's hopping sequence must visit all channels before revisiting a channel. In one implementation, a frequency hopper can be used that guarantees this result by using a pseudo-random hopping sequence that repeats each epoch. In other words, the channel that is employed during a given time slot of the epoch is always the same. This concept is illustrated in FIG. 2, which shows a hypothetical hopping sequence for a node using 10 channels.

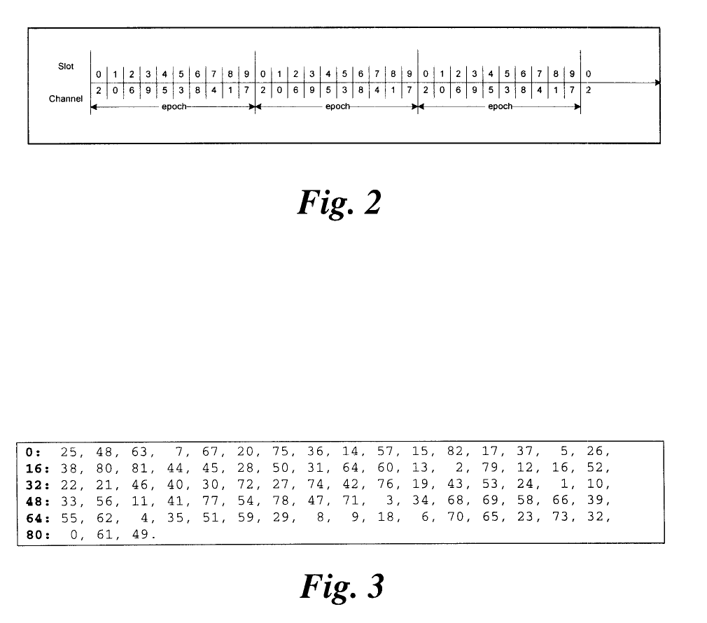

In FHSS communication systems, a transmitting node needs to know where an intended receiving node is in its hopping sequence, in order to transmit data to the receiving node on the proper channel at a given time. For instance, a table of the channel sequence can be stored at each node. FIG. 3 illustrates an example of such a table for a hopping sequence having 83 slots per epoch. This table is implemented as an array. When a transmission is to occur, the transmitting node employs the table to obtain an index, i.e. a channel identifier, from the table. The channel index is a parameter whose value is known a priori to both the transmitting and receiving nodes, which enables them to be synchronized for communication. Various techniques for determining the channel index for an intended receiving node can be employed. One such technique, in which the channel index is dynamically determined at the time of transmission, is described in U.S. application Ser. No. 12/005,268, filed Dec. 27, 2007, whose disclosure is incorporated herein by reference.

In accordance with one implementation of the present invention, an identifier of the transmission channel for a given packet, such as the channel index, can be employed as a seed for a scrambling algorithm that is used to whiten or scramble the data of that packet. Consequently, the scrambling seed will be different for each channel in the hopping sequence, so that a given data packet will be scrambled into two different sequences of bits when transmitted over different respective channels. Even if the scrambling for one channel results in the generation of a killer packet, the scrambling for another channel has a low probability of also generating a killer packet. Therefore, a minimum number of retransmissions of the data packet will be required to overcome the condition posed by the initial presence or generation of a killer packet.

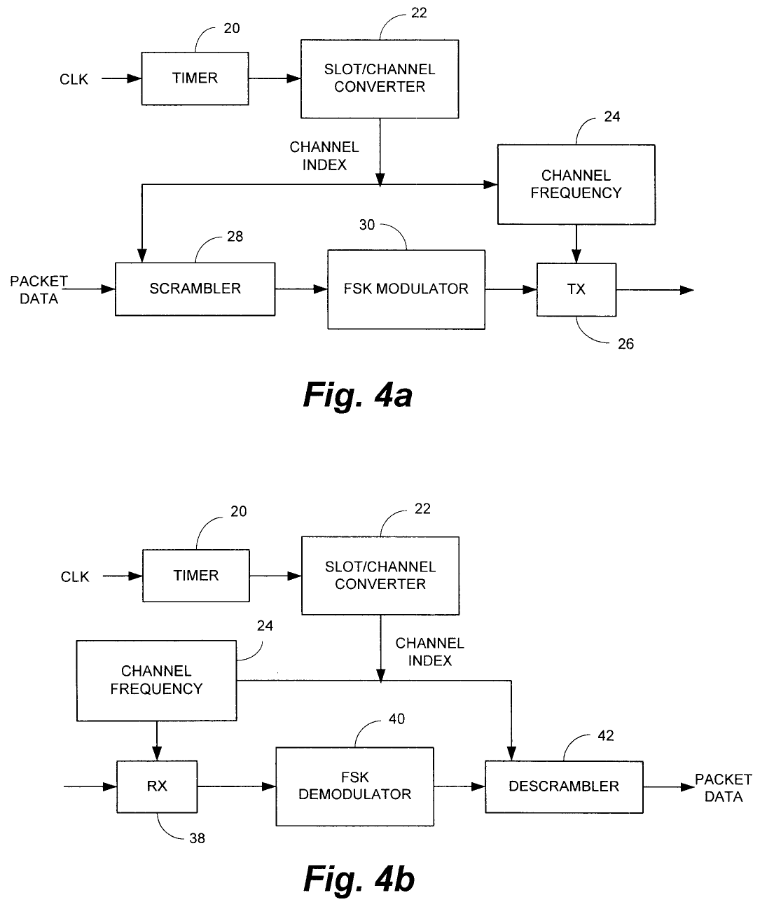

An exemplary embodiment of this implementation of the invention is illustrated in FIGS. 4a and 4b. The operation that occurs at the transmitting node is depicted in the block diagram of FIG. 4a. A clock signal CLK is input to a timer 20, to identify the slots of the FHSS epoch. In essence, the timer 20 functions as a frequency divider, whose output indicates the beginning of each new time slot. These time slot indications are fed to a slot-to-channel converter 22, which produces a corresponding channel index for each new time slot. The slot-to-channel converter 22 may employ an array, such as that illustrated in FIG. 3, to perform this conversion. The channel index is used to determine the appropriate transmission frequency for that time slot, in a channel frequency converter 24. The determined frequency is provided as an input signal to a transmitter 26.

The data for a given packet to be transmitted is input to a scrambler 28, which functions to whiten the data by changing the order and/or values of its bits. The scrambled data is provided to a modulator 30, such as a frequency-shift-keyed (FSK) modulator, to generate a modulated data signal in which the bits of data are represented by symbols. This modulated data signal is then transmitted by the transmitter 26, on the appropriate carrier frequency that is determined in accordance with the channel index.

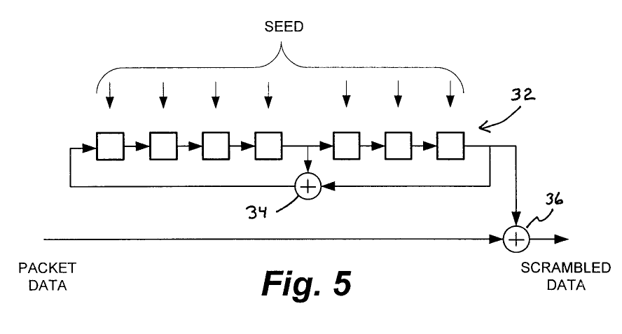

In the illustrated embodiment, the starting seed for the scrambling of the packet data is varied on a channel-by-channel basis, to enable quick recovery from the inadvertent generation of a killer packet in the whitening of the data by the scrambler. To this end, the channel index generated by the slot-to-channel converter 22 is input to the scrambler as a seed value. To illustrate, an example of a scrambler is shown in FIG. 5. In the depicted example, a 7-bit linear feedback shift register 32 is employed, in which the values of the fourth and seventh bits are processed in an Exclusive-OR gate 34, to produce the feedback bit that is input to the first register. The seventh, output bit is also fed to an Exclusive-OR gate 36, where it is combined with one bit of the packet data, to produce a scrambled bit.

Typically, in a scrambler of this type, all of the registers of the linear feedback shift register 32 might be initialized with a value of 1. In the exemplary embodiment illustrated in FIG. 4a, however, the channel index is used to initialize the registers. Since the channel index varies for each transmission channel, the seeding, or initialization, of the scrambler with different values for each channel results in a different scrambled output.

FIG. 4b illustrates circuitry at the receiving node, where the converse of the scrambling operation is performed. Referring thereto, the channel index is employed to determine the appropriate receive channel frequency, which is fed as a control input to a receiver 38. The received signal is demodulated in a demodulator 40, to derive the data bits from the received symbols. These data bits, which are in the scrambled sequence, are provided to a descrambler 42, which is identical to the scrambler 28. This descrambler is also initialized with the channel index, so that the descrambling operation mirrors the scrambling that took place in the scrambler 28 at the transmitting node. The output of the descrambler 42 comprises the original packet data, which can then be decoded in accordance with conventional techniques.

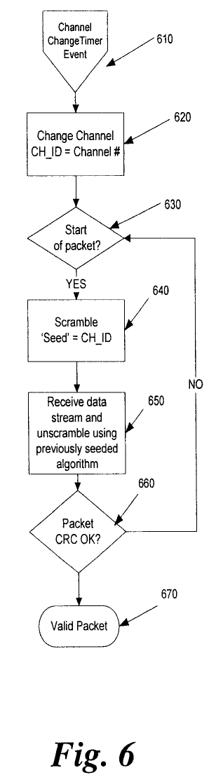

The overall process that is carried out in the embodiment of FIGS. 4a and 4b is illustrated in FIG. 6. The process is triggered by a Channel Change Timer Event 610 generated by the timer 20. Both the transmit node and the receive node identify the new channel index at step 620 to alter the scrambling code and configuration of the packet for the new hopping sequence channel. The start of a data packet is detected at step 630. To begin the scrambling process for the data packet in the new channel, the scrambling seed is set to be equal to the channel index at step 640. The receiver initializes the descrambler with this seed value, and receives the packet at step 650. A CRC check at step 660 determines whether the receiver is able to read the packet bits. If the check turns out to be satisfactory after data descrambling, the data is processed by the receiver as a valid packet at step 670. If the CRC check 660 is negative, then a message is sent back to the transmit node informing it of the failed packet. The transmit node reconfigures the next available channel with a different scrambling seed based on the new channel index, and retransmits the packet. If the failure at the receiver is due to a killer packet event, the situation will not repeat for the retransmitted packet with a new scrambling seed in a new channel.

As previously noted, various techniques are known for determining the channel index for a given time slot. In some of these techniques, the channel index is independently determined at each of the transmitting and receiving nodes, for example as disclosed in application Ser. No. 12/005,268. In these situations, it is not necessary to transmit the channel index as part of the packet information. In other instances, however, it may be desirable to include the channel index in the information of a packet as a fallback provision. By doing so, the transmission of the data packet can be made more robust. In particular, the channel index provides additional data to enable the start of a received packet to be reliably detected.

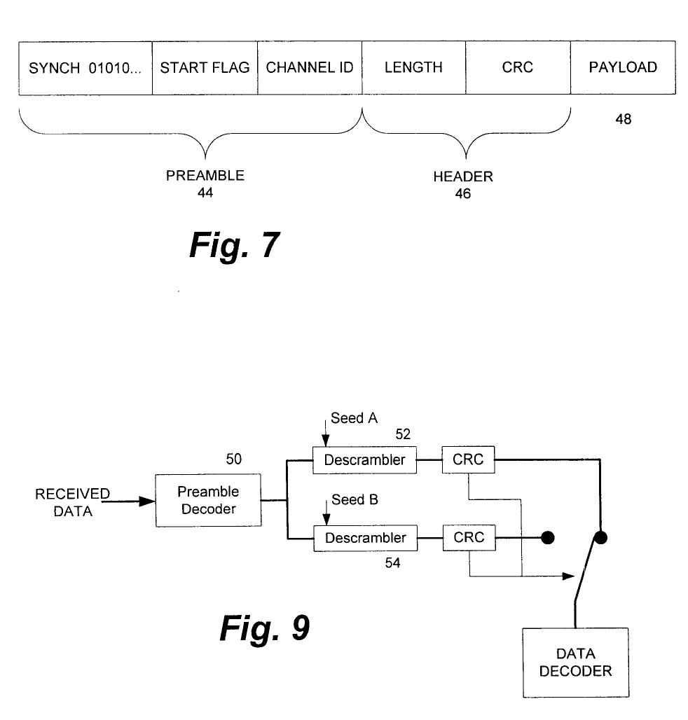

FIG. 7 illustrates the data structure of a packet. The packet consists of three main components, a preamble 44, a header 46, and a payload 48. The payload data is scrambled, whereas the preamble and header are sent in the clear, i.e. non-scrambled. The preamble comprises an alternating sequence of 0 and 1 bits, to enable the receiving node to detect a signal and achieve frequency and timing synchronization with the remainder of the received packet. This synchronization field is followed by a start flag. This start flag comprises a known sequence of 0 and 1 bits that, when successfully decoded, trigger the receiving node to decode and unscramble the packet data that follows. Among other features, the start flag provides symbol-level synchronization, and optimizes autocorrelation properties in conjunction with the preamble sequence of alternating 1 and 0 bits that preceded it.

In accordance with one aspect of the invention, the channel index can be included in the preamble of the packet. In effect, the channel index functions as an extension of the start flag, and thereby increases the robustness with which the beginning of a packet is detected. More particularly, if the start flag is comprised of a single byte, false positives may result. In this situation, a sequence of bits is incorrectly interpreted as a start flag, and causes the receiver's circuitry to begin decoding unintelligible data. To reduce the likelihood of false positives, a 2-byte start flag is more preferable. Even in this case, however, some false positives may still occur. By including the channel index at the end of the start flag, additional information is provided to the receiving node for verification of the beginning of the packet data. A packet is processed only if the detected channel index in the preamble matches that of the channel on which the receiving node is currently operating, to thereby reduce the unnecessary consumption of power by the decoding circuitry that can occur in the case of a false positive.

In the foregoing example, the channel index is employed as the seed for initializing the scrambler when a packet is received. Because the channel index is known a priori to both the transmitting node and the receiving node, it can be reliably employed for this purpose. It will be appreciated that parameters other than the channel index can also be employed for such a purpose. For example, in networks where the nodes are time-synchronized with one another, a time-based value can be used as the seed for the scrambling algorithm. For instance, the digital value for the current minute and seconds might constitute the seed.

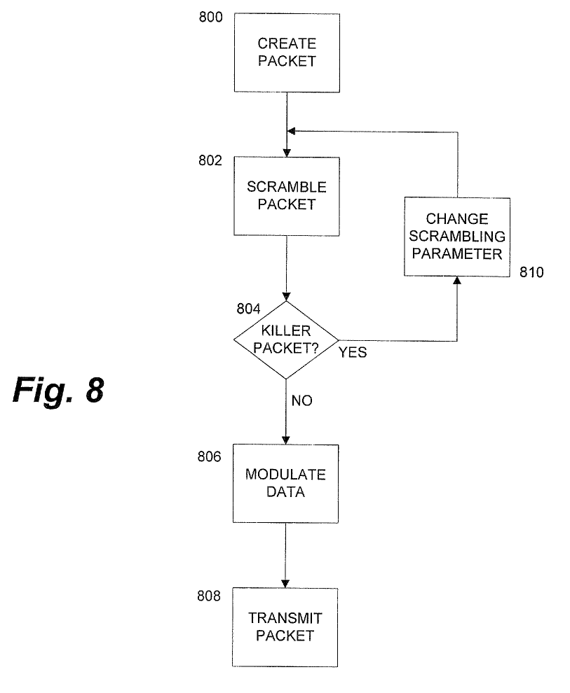

In the preceding examples, the detection of a killer packet occurs at the receiving node. In response to detecting this condition, the receiving node transmits an error message to the originating node, which causes the packet to be re-transmitted, using a different value for the scrambling parameter, e.g. the initial seed value. In another implementation, the transmitting node can detect the existence of a killer packet before it is transmitted, and rescramble the data packet using a different value for the scrambling parameter. One embodiment of this implementation is illustrated in FIGS. 8 and 9. FIG. 8 is a flowchart illustrating the process that is performed at the transmitting node. At step 800, a data packet is generated for transmission. This packet is then scrambled, at step 802, for example by using a scrambler 28 as illustrated in FIGS. 4a and 5. The scrambling is executed with a predetermined seed value, A, that is known at both the transmitting node and the receiving node. At step 804, the scrambled data is examined, to determine whether it might result in a killer packet. For example, a detector might count the number of successive bits in the scrambled bit sequence that have the same value. If the count reaches a predetermined number, e.g. six, the scrambled data is identified as a potential killer packet.

If the scrambled data does not qualify as a potential killer packet, it is modulated and transmitted at steps 806 and 808, for example as depicted in FIG. 4a. If, however, the determination at step 204 indicates that the scrambled data could result in a killer packet, the scrambling parameter is changed to a second, known value B at step 210, and the original data packet is re-scrambled at step 802, using the value B as the scrambling parameter. After the second scrambling, the scrambled data is again evaluated to see if it is a potential killer packet, at step 804. Statistically, the new value for the scrambling parameter is unlikely to produce a similar result, and therefore the re-scrambled packet can be transmitted. If, however, a killer packet is still present, the packet can be re-scrambled with yet another known value for the scrambling parameter.

When a packet is received, the receiving node may not know which of the parameter values was employed to scramble the received packet. To this end, therefore, the receiving node performs multiple descramblings of the received packet. Referring to the logical schematic diagram of FIG. 9, an incoming signal is first processed in a preliminary decoder 50, which decodes the incoming preamble to detect whether a start frame is present in the received symbols. If so, the payload data of the packet is provided to each of two descramblers, 52 and 54. One of the descramblers, 52, is initialized with one of the known seed values, A, and the other descrambler, 54, is initialized with the other known seed value, B. Depending on the seed value that was used to scramble the payload data of the received packet, the output of one of the descramblers will be meaningless, but the output of the other descrambler will comprise the correctly descrambled data. Selection of the currently proper one of the two descramblers can be made by performing a CRC check on the output data of each descrambler. The output data that exhibits the correct CRC results can be used to control a selector to pass that data along for further processing, such as decoding of the payload.

In the embodiment of FIG. 9, the receiving node performs both descramblings in parallel. In an alternative embodiment, utilizing serial processing, the received data can first be descrambled using one of the two seed values, and if the CRC check is not positive, the same data can then be descrambled using another one of the known seed values, before passing that data along for further processing.

From the foregoing, it can be seen that the present invention provides an effective technique to prevent network bottlenecks that occur when killer packets are transmitted. If the scrambling of a data packet inadvertently generates a killer packet, the data packet is rescrambled using a different value for the scrambling parameter. The probability that the re-scrambled version of the data packet will also result in a killer packet is statistically quite small. Consequently, a given data packet may only need to be processed a maximum of two times, thereby decreasing the resources that are affected by a killer packet.

When implemented in a network that employs FHSS transmissions, one embodiment utilizes the channel index as a seed for the scrambling algorithm. In addition to varying the seed on a channel-by-channel basis, to overcome the effects of a killer packet, this embodiment offers a number of other advantages. In particular, the channel-by-channel change in the scrambling seed increases the security of the transmissions. One type of attack that can occur on a network is a replay assault, in which an intercepted packet is replayed back into the network. In order to be successful in the context of the disclosed embodiment, an attacker would need to know the specific channel on which the intercepted packet was transmitted, and replay it on that same channel. If it is transmitted on any other channel, it may not be properly received and processed, and therefore may be discarded. As a result, the receiving node circuitry will not be overburdened by decoding replayed packets.

Security is also enhanced by the fact that an eavesdropper will need to know the scrambling seed in order to unscramble an intercepted packet. Even if the eavesdropper is able to discover the seed for one of the channels, it will not be of any value for packets that are transmitted on any of the other channels of the frequency hopping spectrum.

In the foregoing examples, the seed value for the scrambling algorithm is employed as the parameter that is varied to overcome the effects of a killer packet. It will be appreciated that other parameters of the scrambling algorithm can be varied to achieve the same effect, in addition to, or in lieu of, the seed value. For example, the scrambling algorithm itself might be varied. To illustrate, in the exemplary scrambler of FIG. 5, an Exclusive-OR operation is performed on the fourth bit and the seventh bit of the value stored in the linear shift register, to produce the feedback input bit. To vary the algorithm, one or both of the inputs to the Exclusive-OR gate 34 can be changed. For instance, a switch might be employed to selectively apply either the third bit or the fourth bit as one of the inputs to the Exclusive-OR gate 34. The selection of one of these two bits can be based upon the value of a particular bit in the channel index, e.g. the least significant bit, or any other value that is known to both the transmitting and receiving nodes.

The scrambling algorithm can be driven by any number of parameters that can be dynamically varied. In addition to employing different scrambling parameters, such information may also be known to the receiving target node in real time. For example, it can be transmitted in the form of packet preamble bits, in unicast data packets.

From the foregoing, therefore, it will be appreciated that the invention can be embodied in a variety of forms, without departing from the spirit or essential characteristics thereof. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

What is claimed is:

1. A transmitting node for use in a wireless communications network that communicates data packets between a transmitting node and a receiving node, comprising:
a data scrambling unit that receives packet data and modifies said data in accordance with the value of a parameter of a scrambling algorithm;
a parameter value generating device that generates different values that are known a priori at the receiving node, and inputs individual generated values to said data scrambling unit as said parameter value; and
a transmitter that transmits said modified data to the receiving node via said wireless communications network.

2. The node of claim 1, wherein said parameter value is varied on a periodic basis.

3. The node of claim 2, wherein said wireless communications network employs frequency hopping transmissions, and wherein said parameter is an identifier associated with the frequency of a transmission channel.

4. The node of claim 2, wherein said scrambling parameter is a seed value with which the scrambling algorithm is initialized.

5. The node of claim 2, wherein said scrambling parameter is a time code.

6. A system for communicating data packets between a transmitting node and a receiving node in a wireless communications network that employs frequency hopping, wherein packets are transmitted via different frequency channels during successive periods of time, each said node comprising:
a data scrambling unit that receives packet data and modifies said data in accordance with an input seed value;
a transceiver that transmits and/or receives modified data communicated via said wireless communications network; and
a channel identifier that generates a value indicating the frequency channel being employed for data communications at any given instant of time, and inputs said value to said data scrambling unit as said seed value, to thereby cause data to be scrambled in different manners in accordance with the channel via which it is transmitted.

7. A method for communicating data packets between a transmitting node and a receiving node in a wireless communications network, comprising the following steps:
scrambling packet data in accordance with a first value for a scrambling parameter that is input to a scrambling algorithm, to produce a first set of scrambled data;
determining whether said first set of scrambled data contains a sequence of data bits that cannot be reliably detected at said receiving node;
scrambling said packet data in accordance with a second value for said scrambling parameter, to produce a second set of scrambled data if a determination is made that said first set of scrambled data contains a sequence of bits that cannot be reliably detected; and
transmitting a packet containing said second set of scrambled data to said receiving node.

8. The method of claim 7, wherein said determining step is performed at said transmitting node.

9. The method of claim 7, wherein said receiving node performs the following operations:
descrambling data of a received packet in accordance with each of said first and second values for said scrambling parameter, to produce two descrambled packets from said received packet;
selecting one of said two descrambled packets as containing reliable data; and
processing said selected packet to decode the data contained therein.

11. The method of claim 7, further including the steps of transmitting a packet containing said first set of scrambled data to said receiving node, and wherein said receiving node performs said determining step in response to receiving said packet containing said first set of scrambled data.

12. The method of claim 7, wherein the determination whether a sequence of data bits cannot be reliably detected is based upon whether the sequence contains a predetermined number of successive bits all having the same value.

13. The method of claim 7, wherein said scrambling parameter is a seed value with which the scrambling algorithm is initialized.

14. The method of claim 13, wherein said wireless communications network employs frequency hopping transmissions, and wherein said parameter is an identifier associated with the frequency of a transmission channel.

15. The method of claim 7, wherein said wireless communications network employs frequency hopping transmissions, and wherein said parameter is an identifier associated with the frequency of a transmission channel.
